(19) United States
(12) Patent Application Publication
(10) Pub. No.: US 2009/0132232 A1
(43) Pub. Date: May 21, 2009

(54) METHODS AND APPARATUS FOR IMPLEMENTING MULTILINGUAL SOFTWARE APPLICATIONS

(75) Inventor: Alan Trefler, Brookline, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Pegasystems Inc., Cambridge, MA (US)

(21) Appl. No.: 12/174,624

(22) Filed: Jul. 16, 2008

Related U.S. Application Data
(63) Continuation-in-part of application No. 12/035,682, filed on Feb. 22, 2008.
Application No. 12/035,682 is a continuation-in-part of application No. 11/396,415, filed on Mar. 30, 2006.
(60) Provisional application No. 61/063,269, filed on Jan. 31, 2008.

(51) Int. Cl. G06F 17/28; G06F 17/20

(52) U.S. Cl. 704/2; 704/8

(57) ABSTRACT

The invention provides, in some aspects, a system for implementing a multilingual rules-based user interface including a reference tracker (executing on a digital data processor) that identifies translatable elements—by way of example, static text, enumerated variable text, images and icons—referenced by one or more user interface rules in a rules base and that generates a translation package containing those translatable elements for at least one target locale. A rules engine (which may execute on the same or another digital data processor) retrieves, from one or more transliteration rules based on the translation facilitation package, one or more translated elements that are associated with a locale and with one or more translatable elements referenced by the user interface rules. The rules engine processes those user interface rules using those one or more translated elements and, as a result, generates a user interface with the one or more translated elements.

### CROSS-REFERENCE TO RELATED APPLICATIONS

This application claims the benefit of priority of U.S. Patent Application Ser. No. 61/063,269, filed Jan. 31, 2008, entitled “Digital Data Processing Methods and Apparatus for Business Process Management,” the teachings of which are incorporated herein by reference. This application is also a continuation-in-part U.S. patent application Ser. No. 12/035,682, filed Feb. 22, 2008, entitled “User Interface Methods and Apparatus for Rules Processing,” which is a continuation-in-part of U.S. patent application Ser. No. 11/396,415, filed Mar. 30, 2006, entitled “User Interface Methods and Apparatus for Rules Processing,” both of which are incorporated herein by reference.

### BACKGROUND OF THE INVENTION

The invention relates to digital data processing and, more particularly, to facilitating locale globalization and/or customization for digital data processing user interfaces. The invention has application, by way of non-limiting example, to enabling multilingual enterprise software systems that can customize user interactions to each user's language and cultural expectations.

As a result of the internet, businesses are no longer restrained by geographical barriers. Businesses require the flexibility to work across languages, countries and cultures with world-ready business solutions. In order to fully take advantage of worldwide business opportunities, Global enterprises need to communicate with their customers over the Web in accordance with the customer's cultural expectations. At the same time, enterprises themselves may have internal business processes that need to operate in the language of users in different locales, store global data in a common format and have the ability to have local variations of processes to take account of cultural differences.

Consider the example of a bank that is located in Belgium and has customers all over Europe. The three major languages spoke in Belgium are French, Flemish and German. The bank's process for handling customer account inquiries may start with a French-speaking customer service representative who wants the data presented to him on his computer screen in French. The process may then pass the request on to the company lawyer who is a Flemish speaker who needs to see the data in his own language. On the other hand, the customer may be a British citizen who wants all his correspondence from the bank in English. Any enterprise computer system used by the bank to automate its account inquiry process will need to provide multi-language capabilities to both the application user and the customer.

In information technology, Internationalization is the process of designing a software application such that a single instance of its executable code can provide multilingual and multicultural capabilities without the need for additional coding changes to the application code. Localization is the adaptation of the application for different locales (i.e. geographical regions, languages and/or variants) by translating text and adding various elements that take into account local customs and laws. In other words, an application that supports multiple locales needs to be internationalized once and may need to be localized multiple times (e.g., once for each locale). Companies such as IBM and Microsoft use the term globalization to denote the combination of internationalization and localization.

Global organizations deploying changes across geographies face slow and costly translation cycles to translate and localize their enterprise software applications. The general practice is that developers fails to design source code for internationalization. This can make later translations for localization very expensive to implement. For example, hard coded text in the source code for error messages or other display elements necessitates translating the source code for every single locale and results in each locale having its own version.

The more efficient prior art approach to internationalization is to isolate all instances of locale-sensitive data (e.g. translatable text) of an application into resource files and to design locale-independent code to load the appropriate resource file at runtime. Thus, in order to achieve an application that supports multiple locales a designer creates resource files for each locale and writes the source code to load the appropriate file for each interface. Still, however, several problems remain with this approach that limit the ability to globalize applications.

For example, the foregoing approach does not provide global enterprises with a way to avoid high costs of translating existing applications that were not internationalized when first written. Furthermore, even for applications that have been internationalized, there is no efficient way of providing context of actual usage to the translators in order to remove ambiguity in translating local-sensitive data and to ensure consistent vocabulary and fit. Moreover, the overall performance of most prior art globalized applications remains relatively slow since, typically, locale-sensitive data is retrieved (e.g., from resource local or networked resource files) at run-time. Finally, conventional methods and apparatus do not provide the ability to define additional factors (other than locale) when translating user interfaces.

In view of the foregoing, an object of the invention is to provide improved methods and apparatus for digital data processing.

A related object is to provide such methods and apparatus as facilitate globalization and/or customization of user interfaces.

A further related object of the invention is to provide such methods and apparatus as facilitate multilingual enterprise software systems that can customize user interactions to each user's language, cultural expectations and personal preferences.

Yet a still further object of the invention is to provide such methods and apparatus as provide more flexibility to build efficient globalized applications.

A still further object of the invention is to provide such methods and apparatus as can be used with legacy, as well as new, applications.

Yet a still further object of the invention is to provide such methods and apparatus as can be implemented and operated at reduced expense on existing and new platforms.

### SUMMARY OF THE INVENTION

The foregoing are among the objects attained by the invention which provides, in some aspects, a system for implementing a multilingual rules-based user interface including a reference tracker (executing on a digital data processor) that identifies translatable elements—by way of example, static text, enumerated variable text, images and icons—referenced by one or more user interface rules in a rules base and that generates a translation package containing those translatable elements for at least one target locale. A rules engine (which may execute on the same or another digital data processor) retrieves, from one or more transliteration rules based on the translation facilitation package, one or more translated elements that are associated with a locale and with one or more translatable elements referenced by the user interface rules. The rules engine processes those user interface rules using those one or more translated elements and, as a result, generates a user interface with the one or more translated elements.

Further aspects of the invention provide systems as described above in which the reference tracker identifies translatable elements by querying a database table made up of entries identifying those elements and the user interface rules that reference them. Alternatively or in addition, the reference tracker may, according to related aspects of the invention, identify translatable elements by inspecting the user interface rules.

Still further aspects of the invention provide systems as described above in which the target locale can be a language (e.g., German, French, etc.), a country and language (e.g., Switzerland/French), and/or a country and language and a variant (e.g., Switzerland/French/pre-Euro).

Yet further aspects of the invention provide systems as described above in which the rules engine parses the translation facilitation package to extract the translated elements and, thereby, to generate the transliteration rules.

Still further aspects of the invention provide systems as described above wherein the rules engine retrieves translated elements from the transliteration rules in accord with a context (other than or in addition to locale) in which the user interface will be transmitted to and/or executed by a client device, and/or of a user on behalf of which the user interface will be executed. That context can include, by way of example, security permissions, age, disability settings, behavioral segment, market segment, and locale of the user on behalf of which the page is executed; a processor speed, display size, and keyboard capabilities, of the client device; and, a speed of connection between the client device executing the user interface and the first digital data processor of a second set of one or more digital data processors.

Other aspects of the invention include systems as described above in which the rules engine processes the user interface rules by converting metadata associated with them into executable code, e.g., Java code. In related aspects of the invention, the rules engine incorporates the translated elements into the user interface rules prior to executing that code, e.g., by transforming both metadata for the user interface rules and for the transliteration rules into a single executable Java (or other language) file.

Still other aspects of the invention provides systems as described above in which the reference tracker generates translation facilitation packages that further includes (i) previously translated elements and (ii) indicators of exemplary references (e.g., hypertext links to markup text for the user interface or text descriptions of the exemplary reference) by the user interface rules to any of (i) one or more translatable elements, (ii) one or more previously translated elements.

Yet still other aspects of the invention provide systems as described above in which the reference tracker identifies previously translated elements by inspecting any of transliteration rules, files and tables.

In other aspects, the invention provides a system for implementing a multilingual rules-based user interface that includes functionality, e.g., a ‘wizard’, executing on a digital data processor, that identifies one or more translatable elements referenced by one or more user interface rules in a rules base. That wizard (or other functionality) requests, from a user, one or more translated elements associated with those translatable elements and with at least one target locale. From this, the wizard generates one or more transliteration rules for such target locales.

Such a system further includes a rules engine, executing on the same or another digital data processor, that (i) retrieves from the transliteration rules generated by the wizard one or more translated elements associated with a specified locale and with one or more translatable elements in one or more user interface rules, (ii) processes those interface rules using those one or more translated elements, to generate a user interface with the one or more translated elements.

Such a system can include one or more elements of the systems described above.

In other aspects, the invention provides methods of implementing a multilingual rules-based user interface that parallel operation of the systems described above.

These and other aspects of the invention are evident in the drawings and in the description that follows.

### BRIEF DESCRIPTION OF THE DRAWINGS

A more complete understanding of the invention may be attained by reference to the drawings, in which:

FIG. 1 depicts a digital data processing system of the type in which the invention is practiced;

FIG. 2 depicts further details of the translation facilitation packages and transliteration rules used in operation of the system of FIG. 1;

FIG. 3 is a flowchart depicting a method of operation of the system of FIG. 1;

FIG. 4 is a flowchart depicting further details of the translation facilitation package generation step of the flowchart of FIG. 3; and

FIG. 5 is a flowchart depicting the conversion of metadata into executable Java code in one embodiment of a system according to claim 1.

### DETAILED DESCRIPTION OF THE ILLUSTRATED EMBODIMENT

Architecture

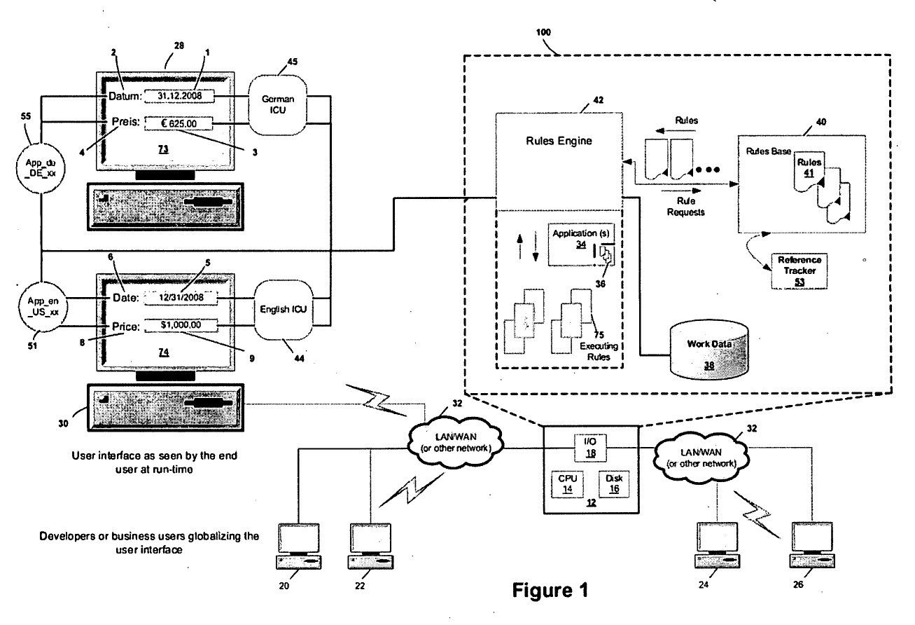

FIG. 1 depicts a system 100 and environment for globalizing the user interface of software applications 34, particularly, for example, a multi-user enterprise application, according to one practice of the invention. In the illustrated embodiment, system 100 executes on exemplary server digital data processor 12, which may be a personal computer, workstation, mainframe, or other digital data processing apparatus of the type known in the art capable of executing applications, programs and/or processes.

Illustrated server digital data processor 12 executes in a network environment of the type typical in a business enterprise, e.g., one including further digital data processors 20-30—which themselves may comprise personal computers, workstations, mainframes, or other digital data processing apparatus. In other embodiments, server digital data processor 12 may operate alone or in other environments, networked or otherwise. In any event, illustrated digital data processors 20-30 are coupled to server 12 via a network 32, such as the Internet, a local-area network (LAN), wide-area network (WAN), or otherwise, that may be public, private, IP-based, etc.

In a typical embodiment, illustrated here, client data processors 20-26 are used in development mode, e.g., by software engineers, test engineers, systems administrators, etc. (collectively, “developers”) to develop, test and maintain/or software applications 34. Likewise, client data processors 28 and 30 are employed by users to execute instantiations of the application 34.

In the discussion that follows, server 12 assumes the roles of development devices 20-26, i.e., it is treated as if used by developers to develop, test and maintain the applications, as well as the role of executing application 34 at the behest of client devices 28, 30. Moreover, it is also assumed for sake of simplicity of discussion that applications 34 execute on a single digital data processor; however, in practice, the applications 34 may execute on or over multiple digital data processors (e.g., in client-server mode, peer-to-peer mode, etc.).

Illustrated digital data processor 12 includes rules base 40 constructed and accessed in the conventional manner known in the art of rules bases. The digitally encoded rules 41 that it contains are likewise formatted and stored in the conventional manner known in the art. An example of the structure, operation and use of the rules base 40 and rules 41 is provided in commonly assigned U.S. Pat. No. 5,826,250, entitled “Rules Bases and Methods of Access Thereof” and U.S. patent application Ser. No. 11/368,360, filed Mar. 3, 2006, entitled “Rules Base Systems and Methods with Circumstance Translation,” the teachings of both of which are incorporated herein by reference.

Illustrated digital data processor 12 also includes rules engine 42 of the type conventionally known in the art for use in processing rules, e.g., retrieved from a rules base 40, in order to respond to (or otherwise handle) events signaled to and/or detected by the engine 42. Moreover, the illustrated system 100 is shown with a single digital data processor 12 that co-houses both a rules engine and rules base; however, in other embodiments, multiple servers may be provided which may (or may not) include co-housed rules engines and rules bases.

Illustrated applications 34, also executing on the rules engine 42, comprise a set of rules 36 defining the user interface(s) and other aspects of one or more software applications written, tested and revised by developers and executed by users. By way of non-limiting example, such software applications 34 can be multi-user enterprise software systems (e.g., business process management applications), and the like. Moreover, the applications 34 can comprise one or more components, modules, systems, and so forth (collectively, “components”), as is common in the art. Though, in the illustrated embodiment, applications 34 are defined by rules 36 that are executed on engine 42, in other embodiments the applications 34 may be defined and/or executed otherwise.

It will be appreciated that in the case of rules-based applications, a single rule (e.g. a user interface rule) can be unique to a specific application or it can be a generalized rule that is shared by multiple applications. For example, applications 34 may include a student loan processing application as well as a credit card dispute application where the rules are modeled or built in hierarchical classes following an object-oriented paradigm (much like Java). Although the rules defining those applications will generally differ, they may utilize a common rule or set of rules to define various screens (e.g., showing biographical information, such as Name, Contact Information, Income, Gender etc.) and/or processing sequences (e.g., payment or pay-off calculations) that can be inherited and used by multiple applications Generally speaking, during execution of applications 34, rules engine 42 responds to signaling e.g., received from the client devices (e.g., by way of HTTP requests), or otherwise, process rules 36 defining the applications 34. This includes rules (“user interface rules”) for generating user interfaces (or component thereof) for transmittal to the client devices 20-30 for display (e.g., as static web pages) and/or execution (e.g., as Java scripts, Active X objects, or otherwise) by their respective browsers. In these regards, it will be appreciated that although, in the illustrated embodiment, user interface rules (and other rules 36) are executed on server 12 for transmittal to the client devices, in other embodiments, those rules may be executed, instead or in addition, on the client devices directly. An example of a system and method that, among other things, can be used to process rules to generate a user interface is disclosed in the commonly assigned U.S. patent application Ser. No. 11/396,415, filed Mar. 30, 2006, entitled “User Interface Methods and Apparatus for Rules Processing,” the teachings of which are incorporated herein by reference.

As used here, a “user interface” of the type generated by execution of the aforementioned user interface rules may be of any type known in the art including, but not limited to, a graphical user interface (GUI), text user interface (TUI) and command line interface (CLI)—as adapted in according with the teachings hereof. Such TUIs and CLIs may primarily include alphanumeric text-based content, while such GUIs may also include graphic elements, visual indicators, aural presentation fields (e.g., music files), video files and the like.

In the example of FIG. 1, the user interfaces generated and transmitted by server 12 to the digital data processors 28, 30 are shown as conventional GUI “display screens” of the type used to present information to and/or elicit information from users of those devices, (though, as evident from the discussion above, they may be other types of interfaces). Moreover, those screens are embodied in HTML or other mark-up language streams transmitted by the server to the devices 28, 30 and presented by web browsers executing on them (though, in other embodiments, they may be transmitted in other formats and/or executed by other software on the devices 28, 30). Moreover, those screens may be individual, stand-alone screens or they may form part of a sequence of UT screens transmitted by the server 12 to the respective devices 28, 30, e.g., as part of respective online sessions by users of those devices.

The web browsers utilized by digital data processors 28, 30 to present the display screens (or other user interfaces generated by server 12) are of the conventional type known in the art operative on the respective devices for, by way of example, retrieving web pages, presenting those pages (visually, aurally, or otherwise), executing scripts, controls and other code on those pages, accepting user input with respect to those pages (e.g., for purposes of completing input fields), issuing HTTP requests with respect to those pages or otherwise (e.g., for submitting to a server information from the completed input fields), and so forth. As noted, those web pages can be embodied in HTML or other markup-language streams and can include, by way of example, embedded XML, scripts, controls, and so forth, again, per convention in the art, albeit as adapted in accord with the teachings hereof

Systems and methods according to the invention facilitate globalization and/or customization of the user interfaces generated by the user interface rules for the client devices.

This is depicted, by way of non-limiting example, in FIG. 1, in which client digital data processors 28 and 30 are shown displaying alternative forms of the user interface—here, generated by server 12 upon processing of common rules 36 in response to requests by browsers executing on the respective clients 28, 30 for the same (or related) web pages.

Thus, in the example, UT screen 73 is displayed by digital data processor 28 in response to HTML or other codes transmitted to it by server 12 in response to a request for a web page for credit card dispute resolution (the “credit card dispute entry” web page), while UT screen 74 is displayed by digital data processor 30 in response to codes transmitted to it by server 12 in response to a request for that same page, or one related thereto (e.g., a web page generated by the server 12 upon processing of the same user interface rules as those which resulted in the “credit card dispute entry” web page).

In the example, UT screens 73, 74 both include corresponding textual display fields 2 (screen 73) & 6 (screen 74) and 4 & 8 for presenting information to respective users of digital data processors 28, 30. Those respective corresponding fields (and, indeed, the respective screens 73, 74) are generated from the same user interface rules processing on server 12 and they convey the same information; however, they do so in different languages: German in screen 73; American-English in screen 74. Systems and methods according to the invention facilitate this.

In the example, UT screens 73, 74 also include corresponding input fields 1 & 5 and 3 & 9, for accepting/editing date and price data from/by those users. Those respective corresponding fields, too, are generated from the same user interface rules executing on server 12 and they convey the same types of information (e.g., date information in the case of input fields 1 & 5; pricing information in the case of fields 3 & 9); however, they do so in different currencies and formats: European formats in screen 73; American-English in screen 74. Systems and methods according to the invention facilitate this, too.

To illustrate the latter point, the data shown in input fields 1 & 5 and 3 & 9 in the drawing is assumed to come from the same underlying data set, e.g., the same customer record. In practice, this “work data” (e.g., working data entered by, or generated for, users of devices 28, 30 and their respective UIs 73, 74) is likely to be from different customer records. In such a case, systems and methods according to the invention facilitate formatting that data in the manner expected by those users of devices 28, 30, even though the underlying data values themselves may not be the same.

Operation

Operation of the illustrated system 100 in facilitating globalization and/or customization of user interfaces—and, particularly, globalizing/customizing those interfaces from the same user interface rules processed by server 12 can be appreciated by continued reference to FIG. 1 and the example presented there, as further described in the text below. It will be appreciated, of course, that the methodology described here may be applied to a host of applications 34, including and beyond generation of UIs for credit card dispute entry. For simplicity, that methodology is described in respect to requests initiated by client device 30; however, the same methodology is executed by other client devices, e.g., 28, with globalization results of the type depicted in FIG. 1.

Thus, for example, in response to a request for “credit card dispute entry” web page 74 by the web browser of client digital data processor 30, the rules engine 42 retrieves user interface (and other) rules 36, 41 implicated by that request from the rules base 40 (if it has not already done so), as determined by the request itself, the context in which the requested web page will be communicated to and executed on the client device 30, and the state of currently executing rules for that user, all by way of non-limiting example. The rules engine then processes those rules, e.g., in view of that context, to select which input fields (e.g., fields 5 and 9), and displays fields (e.g., fields 6 and 8), as well as which other elements making up the screen 74 (such as submit buttons, icons, graphical elements, etc.), to include in the screen—hereinafter, referred to as a “page” or “web page”—and how to arrange, format and otherwise configure those elements.

In this latter regard, the illustrated system 100 takes into account, by way of example, language, country and/or other locale settings and preferences of the user of device 30 to which the web page is to be displayed. In the example, of FIG. 1, the locale settings for device 30 reflect that the user prefers his/her display in American-English format.

In the illustrated embodiment, this contextual selection and configuration is based on information which is embedded in the rules themselves and/or which forms part of the systematic processing of markup language streams discussed below. It does not require that individual rules 36, 41 be hand-coded with alternative web pages to account for a variety of possible contexts—as is conventional in the art. Moreover, it extends beyond selection and configuration of input and display elements per se. It can also include embedding in headers or other elements of the web pages selected scripts, Active X controls, or so forth that are relevant to a given context, for example, to facilitate further display and use of those pages on the client device 30. Examples of this include, by way of non-limiting example, Ajax and other scripts or other code sequences of the type described in aforementioned incorporated-by-reference U.S. patent application Ser. No. 11/396,415, for the pre-processing of user-entered data, selections and/or gestures, discussed below, thus, altering the user experience by changing the code running on the client device or by making that device dynamically interact.

As noted above, “context” refers to the context in which the requested web page will be communicated to and executed on the client device. That context can include, by way of non-limiting example, user “properties” or business attributes (e.g., security permissions, disability settings, market segment, behavioral segment, age, locale, and so forth), client device 18 properties (e.g., processor speed, display size, keyboard capabilities, locale, and so forth), and communication channel properties (e.g., the speed and type of connection between devices 12 and 30). As further evident in the discussion above, that context further includes the language, country and/or other locale settings and preferences of the user of device to which the web page is to be displayed.

Based on these selections and configuration, the engine 42 constructs a markup language stream, e.g., in HTML or other conventional format or protocol. That stream (or, more accurately, markup language document) is transmitted by the server 12, per convention, to the requesting client digital data processor 30 for response by the user—in this case, review and/or update of input fields 5, 9. In the illustrated embodiment, the engine 42 constructs and forwards the stream to the browser of device 30 substantially concurrently with its request for the corresponding web page, i.e., during the same online session on which that request was made and/or within the conventional time periods expected for response to a web page, though these are not requirements of the invention. The browser of device 30 likewise substantially concurrently executes that stream for display to the user, e.g., within that same online session and/or within the conventional time periods expected for execution of a web page though, again, this is not a requirement of the invention. The resulting user display is shown in FIG. 1, as described above.

Rules engine 42 responds similarly to requests for that same credit card dispute entry web page from the web browser of client digital data processor 28, taking context and, particularly, locale settings into account, as discussed above. In the example, of FIG. 1, the locale settings for device 28 reflect that the user prefers his/her display in German format. The resulting user display is also shown in FIG. 1.

With regard to display and input fields in web pages 73, 74 of FIG. 1, it is evident that rules engine 42 translates the content of the credit card dispute entry web page in accordance with the locale setting specified in client digital data processors' (28 and 30) request for the credit card dispute entry page. If the locale setting is not specified as part of the client's request for the web page, the server 12 will automatically retrieve the client digital data processor's locale setting (e.g., set in the browser executing on the client) at the time of the web page request. Another option is to set the locale on the server 12 that overrides the locale setting of the client or the locale specified in the web page request. In any event, the rules engine 42 will process the user interface rules 36/41 in accordance with the applicable locale setting, although the mode and timing of translation will vary during rules processing in accordance with the type of data being translated.

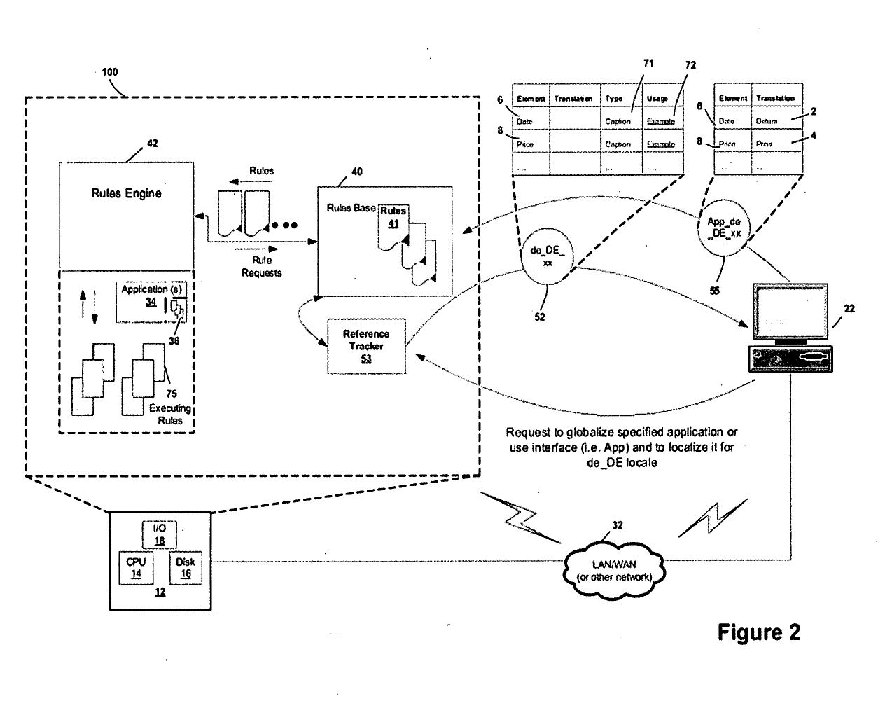

The locale- and related context-dependent elements (hereinafter “translatable elements”) referenced by one or more of those rules 36, 41 that are implicated by the client device 30 request for the “credit card dispute entry” web page, are, preferably, translated prior to runtime by dynamically retrieving data from any of transliteration rules, files and tables (hereinafter “transliteration rules”), as discussed below (see, for example, element 55 of FIG. 2). Such translatable elements preferably comprise all user-visible static alphanumeric text (e.g., labels, captions, tooltips, alert messages, instructions, documents etc.), enumerated variable text (e.g., a list of alphanumeric values that is pre-defined or obtained through a data table look up), graphic elements and indicators, images and icons aural presentation fields (e.g., music files), video files and the like. On the other hand, work data is translated at runtime by the rules engine 42 through the use of software libraries 44, 45 (e.g., Java or C/C++ ICU) or any other method known in the art.

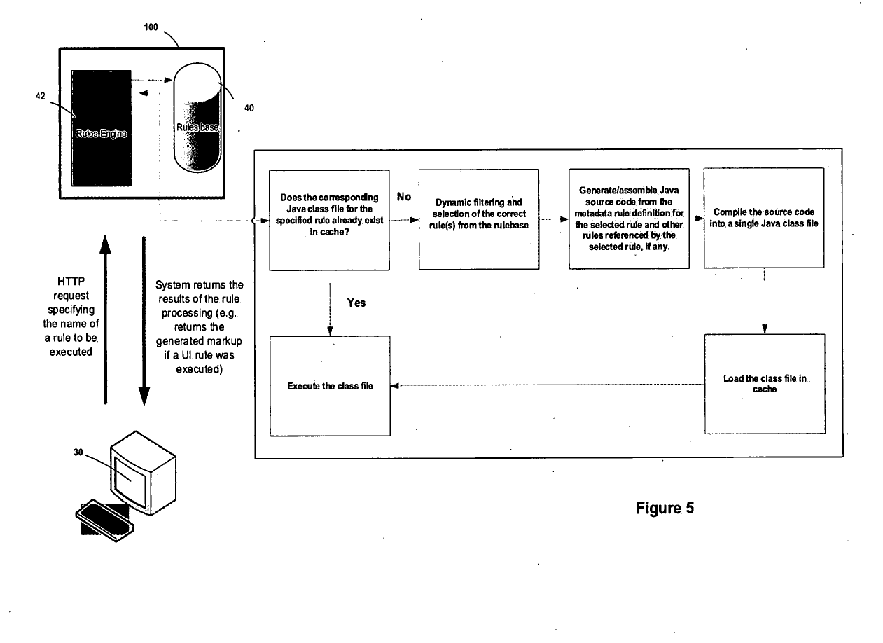

In the illustrated embodiment, rules engine 42 is implemented in Java and uses an XML data structure. Therefore, the functionality of rules that are stored in the rules base 40 as metadata must be translated into Java in order for the digital data processor 12 to execute the functionality defined by such rules. The first time that a particular rule is implicated (for a specific context as defined above), its metadata is extracted from the rules base 40, source code for a unique Java implementation class is generated from the XML, compiled, loaded into a Java cache and then executed. All subsequent references to the same rule (for the same context) will simply reuse the Java implementation class that has already been generated by simply executing the class file previously loaded into Java cache. Furthermore, in order to improve performance, the rules engine 42 generates a single Java implementation class for a rule which references other rules and, therefore, contains generated Java code for such referenced rules. This is illustrated, by way of example, in the flow chart of FIG. 5. It will be appreciated that although in the illustrated embodiment, the rules engine 42 is implemented in Java and utilizes an XML data structure, other embodiments of the rules engine may be implemented in any other programming language and utilize other data formats.

Thus, referring back to FIG. 1 and to the discussion above, when the rules engine 42 is processing the one or more implicated rules 36, 41 (as described above), it extracts the metadata for such rules (e.g., as an XML file) and converts them into source files, e.g., JSP, Servlet etc. These source files are compiled and executed to generate the markup language stream for the requested web page. Rather than translating the entire web page content during execution of the source files, the rules engine 42 processes the transliteration rules (e.g., elements 51, 55 of FIG. 2) and dynamically retrieves the translated values for the translatable elements (e.g., 2, 4, 6 and 8) during creation of the source files associated with the implicated rules 36, 41. In one embodiment, this may be done by incorporating the generated source code for the translation rules into the generated code for the implicated user interface rules. Only the work data is translated during execution of the code, which, in turn, can improve the runtime performance.

By way of example, if a German-speaking customer service representative operating client device 28 is entering a credit card dispute on behalf of a customer, he would want to view the web page and enter work data in his preferred language. The first step is to configure the locale setting of client digital data processor 28 for the German language. Once the rules engine receives the request for “credit care dispute entry” screen with German as the applicable locale, it retrieves the translated values corresponding to the translatable elements (here, captions 2 and 4) from the German transliteration rules 55 (FIG. 2) and include the translated values in the markup generated for web page 73. Once the work data is entered in input fields 1 and 3 and transmitted to the server 12 to be processed and/or stored in a storage medium (here, 38), it is encoded (before storage) using any conventional encoding system (e.g., Unicode) in order to provide a consistent way for handling multilingual text. Subsequent to work data entry, when an English-speaking customer service manager in the United States using client digital data processor 30 wants to review the dispute details on the same screen, the rules engine 42 extracts the work data from storage 38 and uses the applicable locale to determine the appropriate library for the translation. Also, just as the processing for the German web page 73, rules engine 42 will already have processed the transliteration rules 51 and dynamically retrieved the translated values from the American-English prior to the work data translation for web page 74.

The rules engine 42 also manages the hierarchy of transliteration rules used by the rules 41 stored in the rules base 40. In the case that transliteration rules do not exist for an applicable locale, the rules engine 42 will retrieve translated content from transliteration rules that are closest to the applicable locale based upon the locales that are supported and any additional context as defined above. Accordingly, default transliteration rules may be used if no compatible locale can be found.

Thus, it will be appreciated that systems and method according to the invention provide greater flexibility in translating interfaces by giving users the ability to define contexts for the translation of user interfaces in addition to the locale setting. By way of further example, let us assume that a user interface with a field caption Customer Identifier has been translated into German, i.e. German transliteration rules have been created such that the translated value in German for that caption is displayed for all users when the applicable locale is set for the German language. Subsequently, an individual or group of users decide to add some extra space on that user interface as a personal preference and want to shorten the caption to Customer ID without affecting the existing German translations for all other users. As mentioned above, the invention provides the ability to specify an additional context for the translation of Customer ID for such individual user and/or group of users. In other embodiments, the rules engine can assemble the web pages to take into account still other factors, such as user authorization, age, and so forth.

With reference to FIG. 2, system 100 includes a reference tracker 53, which is implemented in software module(s) in communications coupling with the rules base 40 (e.g., via RPC or otherwise). The reference tracker 53 makes the globalization of specified user interfaces less labor-intensive and more efficient by providing the capability to automatically identify translatable elements referenced by the rules stored in the rules base 40. Though, in the illustrated embodiment, reference tracker 53 executes on server 12 separately from the rules engine 42, in other embodiments, the reference tracker 53 itself may comprise rules that are executed on the rules engine. Consistent with the remarks above, though reference tracker 53 is shown as executing on digital data processor 12, it will be appreciated that, like applications 34, it may execute on or over multiple digital data processors.

FIG. 2 also shows transliteration rules 55 used in the system 100 and the translation facilitation package 52 generated by the reference tracker 53 in the illustrated embodiment of the invention. These transliteration rules typically comprise key-value pairing of data where the key (i.e., 6, 8) identifies a translatable element and the value (i.e., 2, 4) is the corresponding translated element. Such rules can also include modified images and icons as necessary for regional considerations. In the illustrated embodiment, transliteration rules 55 are stored in the rules base 40 and may further comprise additional metadata that can be used by the rules engine 42 to identify and process the appropriate rule based upon the specified context.

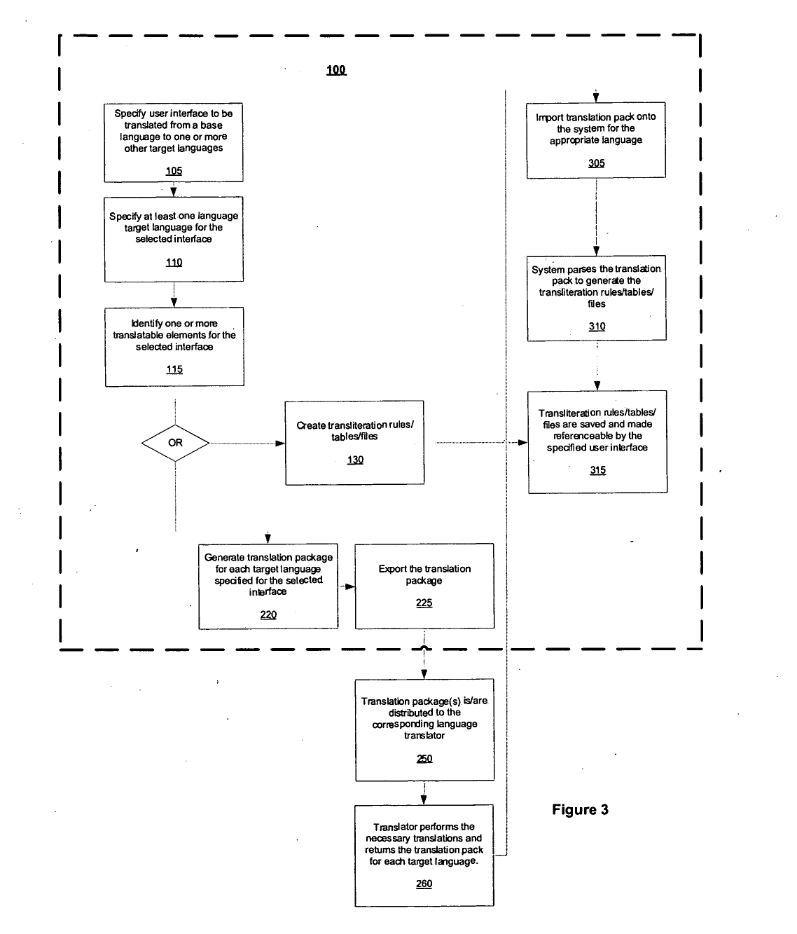

FIG. 3 is a flow diagram depicting further details of the operation of system 100 in globalizing a rules-based user interface of one or more software applications. In step 105, a user (such as, for example, a program developer or field technician) initiates a request via a client digital data processor (e.g., 20-26) specifying one or more user interface rules to be translated from a source language to one or more target locales. The request can be initiated by the user using a wizard interface executing on the client digital data processor, by entering commands on a command line interface executing on the client or through any other method known in the art. Furthermore, the user can structure the request in various ways e.g. by either specifying one or more user interface rules that may (or may not) be used by multiple applications or by specifying one or more applications that need to be globalized.

In step 110, the user (e.g., developer) further specifies at least one target locale to which the user wants to translate the selected application(s) or user interface(s) (hereinafter “user interface(s)”). In the illustrated embodiment, a translation facilitation package (e.g., 52) is created for each of the specified target locales and the corresponding specified user interface(s). In other embodiments, the system 100 simply displays in the client interface (e.g., a wizard interface) used to generate the request, a list of translatable elements (e.g., 6 and 8) referenced by the specified user interface(s) and the user is prompted to enter the corresponding translations for each specified target language. It will be appreciated that steps 105 and 110 can be combined into a single step when initiating the request via a client digital data processor. Similarly, the user interface(s) to be globalized and the target locale(s) can be specified in the same request or one or more different requests initiated by the user. Still further, user can specify additional criteria in these requests depending upon the state of the user interfaces being translated at the time of the request. For example, if part of the specified user interface has already been translated for the specified locale, the user can structure the request to include previous translations of elements for the specified target locale in order to ensure consistency in future translations.

In step 115, reference tracker 53 identifies the translatable elements referenced by the specified user interface(s). In the illustrated embodiment, the reference tracker 53 records or updates an entry in a database table (hereinafter “reference table”) every time a user interface rule is saved to the rules base (i.e., when created or updated). Each such entry has associated therewith, one or more translatable elements, and an identifier of the user interface rule being saved that references said elements. Thus, identification of the translatable elements for the specified user interface(s) in the illustrated embodiment is accomplished by the reference tracker 53 executing a query (e.g., SQL) against the reference table that contains translatable elements and corresponding rule identifiers. In other embodiments that do not utilize such a table, the reference tracker 53 can run specialized queries to extract the specified user interface rule(s) and inspecting the associated metadata (e.g., through parsing, introspection or otherwise) to identify the translatable elements referenced by such rule(s).

As reflected in steps 130-315, the user (e.g., developer) initiating the request can globalize specified user interface(s) in one of two ways. First, as illustrated in steps 130, 315, reference tracker 53 returns a list (e.g., as markup language stream) of all the translatable elements in response to the user's request received from a client digital data processor (e.g., by way of HTTP requests generated through a wizard interface). The list is displayed to the user (e.g., by executing the markup in the client's web browser) and he/she is prompted to enter the corresponding translations for each specified target locale. The user then enters the translated values and transmits them to the server 12, by way of an HTTP request (as conventional in the art), and the rules engine 42 processes the user-entered data to generate transliteration rules 55 that can be referenced to convert translatable elements into the corresponding translated elements and displayed in the specified user interface(s). In step 315, the data for the transliteration rules is stored in one of various conventional storage mediums and data formats e.g., as rules in the rule base 40, CSV or other text-based resource files stored on disk (e.g., 16), data stored in relational database tables or in any other manner conventionally known in the art.

This first approach of allowing the user to directly create the transliteration rules in the system 100 (e.g., through a wizard user interface) is advantageous because the user performing the translations has access to the actual user interface(s) being translated during the translation cycle. Having this ability to see actual usage of the translatable elements removes ambiguity in translating elements to ensure consistent vocabulary and fit. Furthermore, the user is able to take advantage of additional testing tools (e.g., help topics, previewing tools to verify translation results etc.) that may be provided by the applications whose user interface(s) are being translated.

Steps 220-315 illustrate the alternative approach toward globalizing one or more user interfaces where the translations are performed outside the system 100, generally by third-party translators instead of by the user who initiates the translation request. This process is facilitated in steps 220, 225 by the reference tracker 53 generating at least one translation facilitation package (e.g. 52) for each target locale specified for interfaces being globalized. Details of the translation facilitation package generation in step 220 are provided below. Once the translation facilitation package 52 comprising translatable elements 6, 8 referenced by the specified user interface(s) is generated in an easy to manage format (e.g., XML, DOC, RTF, HTML etc.) and exported from the server 12, it is sent to translators in step 250 to perform translations. In step 260, the translators perform the translations either manually, using any conventional computer-assisted translation tool (e.g., CATCount) or in any other manner known in the art. In the illustrated embodiment, the translated values, images and icons (hereinafter “translated values”) are stored in the same translation facilitation package that was previously exported (e.g., 52) from the system 100 in step 225. In other embodiments, the translator may store the translated values in a separate file of any format known in the art (e.g., XML, DOC, RTF, HTML etc.). In any event, the file containing the translated values is uploaded to the server 12 from a client digital data processor (e.g., 20-30) in step 305. Steps 310, 315 illustrate an embodiment where the rules engine parses the contents of the uploaded file using any conventional method known in the art depending upon the format of the uploaded file (e.g., JAXP for XML files, RTF Parser for RTF files etc.). The parsed data is then used to create transliteration rules (e.g., 55) that are stored as described above in step 315. It will be appreciated that in other embodiments, steps 310 and 315 may be skipped all together by e.g., a user manually creating and storing transliteration rules on the system 100 based upon the translated values received from the translator in step 260. Furthermore, any of steps 130-315 might be repeated several times if any changes occur to the user interfaces being globalized during their development process.

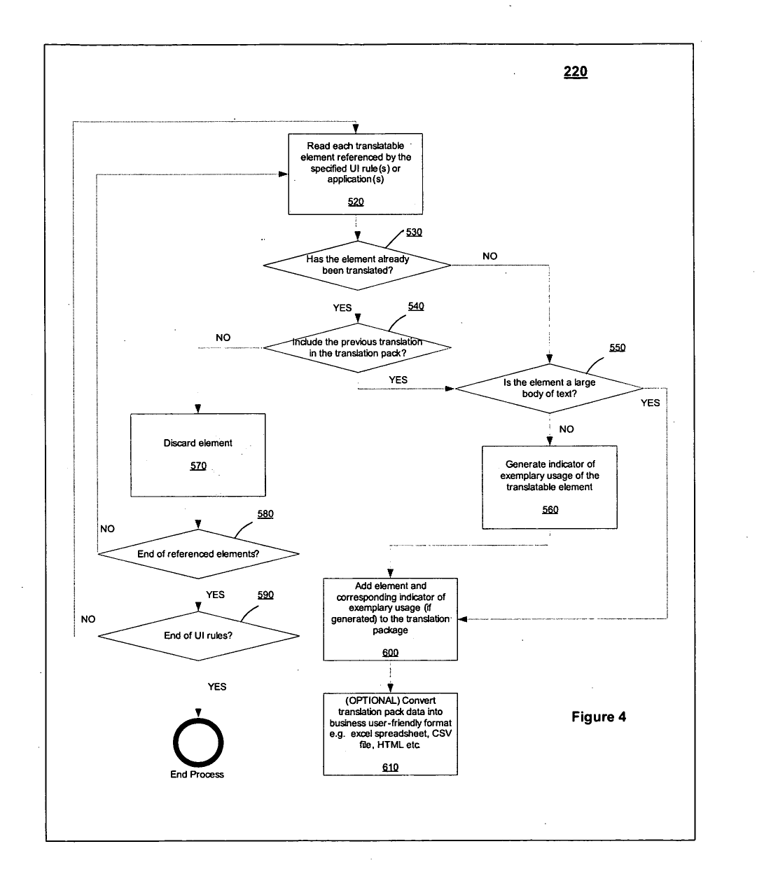

FIG. 4 is a flow chart depicting further details of the translation facilitation package generation step 220 from FIG. 3 in one embodiment of the invention. As previously mentioned, one of the advantages of generating a translation facilitation package to be sent to professional translators (as opposed to the first approach of a user performing the translations in the system 100) is that such third-party translators often employ sophisticated computer-assisted translation tools providing added capabilities (e.g., automated look up of terms in multiple dictionaries, spell-check capabilities in multiple languages etc.) that may not be available to users who are performing the translations in the system 100. However, one major drawback of third-party translators doing translations without access to the actual interfaces is that they have no context of how the translatable elements are actually used in the interface. This, in turn, generally results in inaccurate translations, higher translation costs and longer translation cycles.

The problem stems from the conventional form of translation packages (e.g., Java resource bundles) that are generated using conventional methods and apparatus and that provide nothing more than a listing of the text of the translatable elements. While the illustrated embodiment can permit the generation of this very form of translation package, steps 520-610 illustrate how it also breaks away from convention by generating a translation facilitation package which can incorporate text-based descriptions, prior translations and examples of the actual usage and references of the translatable elements. For example, steps 520-550 illustrate an embodiment where the reference tracker 53 makes determinations with regard to each translatable element identified in step 115 (FIG. 2) for the specified user interface(s). First, the reference tracker 53 queries the storage medium for transliteration rules to determine whether the translatable element in question has already been translated according to the specified locale. In the illustrated embodiment, this is done by querying the rules base 40 where the transliteration rules are stored along with the user interface rules. In other embodiments where the transliteration rules are stored as text files, the reference tracker 53 may employ a parser to determine the translated value. If the element in question has already been translated, the reference tracker will only proceed with the inclusion of the element into the translation facilitation package if the user has specified that option when initiating the translation request in step 105 and 110 (FIG. 2). Otherwise, as reflected in steps 540 and 570 the element will not be included in the translation facilitation package.

In addition to including previous translations into the translation facilitation package, another way to ensure consistency in vocabulary and accurate translations is to provide translators with examples of how the translatable elements are referenced by the user interface rule(s) and some additional contextual information about the elements. However, lack of context is less of a concern when the user interface element being translated is a large body of text such as instructional paragraphs, documents, detailed messages and the like.

In the illustrated embodiment, the reference tracker 53 only includes added contextual information for an element if it is not a large body of text. In the illustrated embodiment, this determination is made in step 550 by the reference tracker 53 based upon the type of user interface being translated (e.g., a correspondence document) and/or the type of element being translated (e.g., tooltip, label, message, instructions, caption, paragraph, image, icon etc.).

In other embodiments, other factors can be considered, such as the maximum length or size of the database field where the element is stored or the number of characters that makeup the element. In any event, if the reference tracker determines in step 550 that the element does not require additional contextual information, it will simply add the element to the translation facilitation package in step 600. However, if for example, the element being translated is a caption for an input field on a screen (e.g., 2, 4, 6, 8), a brief instruction text that appears on a screen, an image of an object/action or any other translatable element that may be translated differently depending upon how it is referenced by the interface, the reference tracker 53 will generate an indicator of exemplary reference in step 560 for the element and include it in the translation facilitation package. In the illustrated embodiment, this indicator is a hyperlink (e.g., element 72 of FIG. 2) to the actual markup stream (e.g., in HTML or other conventional format) of the user interface that references the translatable element along with a textual description (e.g., element 71 of FIG. 2) of the type of element being translated.

In the illustrated embodiment, the translation facilitation package is generated in XML format along with the markup files generated in step 560 for the actual interfaces. This data may be converted into an easy to manage document using conventional methods in step 610. For example, an XML-to-Excel conversion tool can be used to write each translatable element to a separate data field in an Excel spreadsheet or a CSV file, and adding for each said data field, one or more other data fields for storing the translated version of the element and/or the indicator of exemplary usage of the element.

Described herein are methods and systems meeting the objects set forth above, among others. It will be appreciated that the illustrated embodiment and those otherwise discussed herein are merely examples of the invention and that other embodiments, incorporating changes thereto, fall within the scope of the invention. Thus, by way of non-limiting example, it will be appreciated that although the illustrated embodiment utilizes a rules engine that converts metadata into Java code, other embodiment may generate executable code in other programming languages and, indeed, may execute the rules directly upon substitution of the translated elements.

In view of the foregoing, what is claimed is:

1. A system for implementing a multilingual rules-based user interface, comprising:
A. a reference tracker executing on a first digital data processor of a first set of one or more digital data processors, said reference tracker in communications coupling with a rules base comprising a plurality of rules, the reference tracker identifying translatable elements referenced by one or more user interface rules in the rules base and generating at least one translation facilitation package for at least one target locale, said translation facilitation package comprising said one or more translatable elements,
B. a rules engine executing on a first digital data processor of a second set of one or more digital data processors, said rules engine in communications coupling with the rules base, wherein the first and second sets may overlap,
for each of one or more user interface rules, the rules engine
(i) retrieving, from one or more transliteration rules that are based on the translation facilitation package, one or more translated elements that are associated with
(a) one or more translatable elements referenced by that user interface rule,
(b) a locale setting,
(ii) processing that user interface rule using those one or more translated elements,
C. the rules engine generating, as a result of said processing, a user interface with the one or more translated elements.

2. The system of claim 1, wherein the reference tracker identifies the translatable elements by querying a database table comprising a plurality of entries, each entry having associated therewith,
(i) one or more translatable elements,
(ii) an identifier of a user interface rule that references said elements.

3. The system of claim 1, wherein the reference tracker identifies the translatable elements by inspecting user interface rules in the rules base.

4. The system of claim 1, where the target locale can be any of
(i) a specification of a language,
(ii) a specification of a language and country/region, and
(iii) a specification of a language, country/region, and a variant.

5. The system of claim 1, where the rules engine generates transliteration rules by parsing the contents of the translation facilitation package to extract said translated elements.

6. The system of claim 5, where (i) the rules base stores the generated transliteration rules, and (ii) the rules engine processes one or more of the user interface rules in the rules base for generating a user interface by retrieving translated elements from the transliteration rules in accord with a context in which the user interface will be transmitted to and/or executed by a client device, and/or of a user on behalf of which the user interface will be executed.

7. The system of claim 6, where
(i) the user interface rules and transliteration rules are stored as metadata in the rules base, and
(ii) the rules engine processes said rules by converting the metadata associated with said rules into code that is executable on the first digital data processor of the second set of one or more digital data processors.

8. The system of claim 7, where the executable code is Java code.

9. The system of claim 8, where the rules engine incorporates the translated elements into the user interface rules prior to executing said code on said digital data processor by transforming the metadata for the user interface rules and for the plurality of transliteration rules into a single executable Java class file.

10. The system of claim 6, wherein the context includes any of security permissions, age, disability settings, behavioral segment, market segment, and locale of the user on behalf of which the page is executed; a processor speed, display size, and keyboard capabilities, of the client device; and, a speed of connection between the client device executing the user interface and the first digital data processor of a second set of one or more digital data processors.

11. The system of claim 1, wherein
(i) the rules base stores the one or more user interface rules as metadata, and
(ii) the rules engine processes said one or more user interface rules by converting the metadata associated with said rules into code that is executable on the first digital data processor of the second set of one or more digital data processors.

12. The system of claim 11, where the rules engine incorporates the translated elements into the code prior to said code executing on the first digital data processor of the second set of one or more digital data processors.

13. The system of claim 1, wherein the translatable elements comprise any of static text, enumerated variable text, images and icons.

14. The system of claim 1, wherein the reference tracker generates the translation facilitation package to further include any of (i) one or more previously translated elements for the one or more target locales, and (ii) at least one indicator of an exemplary reference by one or more user interface rules in the rules base to any of (a) one or more translatable elements, (b) one or more previously translated elements.

15. The system of claim 14, where the reference tracker identifies the translatable elements and previously translated elements by querying a database table comprising a plurality of entries, each entry having associated therewith an identifier of a user interface rule and any of
(i) one or more translatable elements,
(ii) one or more previously translated elements.

16. The system of claim 14, where the reference tracker identifies
(i) the translatable elements by inspecting one or more user interface rules in the rules base, and
(ii) the previously translated elements by inspecting any of the transliteration rules, files and tables.

17. The system of claim 14, where the indicator of exemplary reference is any of
(i) a link to a markup file depicting a view of the translatable element and/or previously translated element, and
(ii) a textual description of the reference by the one or more user interface rules of the translatable element and/or previously translated element.

18. A method of implementing a multilingual rules-based user interface, comprising:
A. identifying translatable elements referenced by one or more user interface rules in a rules base and generating at least one translation facilitation package for at least one target locale, said translation facilitation package comprising said one or more translatable elements,
B. retrieving, from one or more transliteration rules that are based on the translation facilitation package, one or more translated elements that are associated with
(i) a translatable element in a first user interface rule in the rules base,
(ii) a locale setting,
processing first user interface rule with a rules engine using those one or more translated elements,
C. generating, as a result of said processing, a user interface with the one or more translated elements.

19. The method of claim 18, wherein step (A) includes identifying the translatable elements by querying a database table comprising a plurality of entries, each entry having associated therewith,
(i) one or more translatable elements,
(ii) an identifier of a user interface rule that references said elements.

20. The method of claim 18, wherein step (A) includes identifying the translatable elements by inspecting the user interface rules.

21. The method of claim 18, where the target locale can be any of
(i) a specification of a language,
(ii) a specification of a language and country/region, and
(iii) a specification of a language, country/region, and a variant.

22. The method of claim 18, comprising generating any of the transliteration rules, files and tables based on contents of the translation facilitation package.

23. The method of claim 22, comprising (i) storing the transliteration rules in the rules base, and (ii) processing one or more of the user interface rules in the rules base to generate a user interface dynamically by retrieving translated elements from the transliteration rules in accord with a context in which the user interface will be transmitted to and/or executed by a client device, and/or of a user on behalf of which the user interface will be executed.

24. The method of claim 23, wherein the context includes any of security permissions, age, disability settings, behavioral segment, market segment, and locale of the user on behalf of which the page is executed; a processor speed, display size, and keyboard capabilities, of the client device; and, a speed of connection between the client device executing the user interface and a digital data processor processing said user interface rules in step (C).

25. The method of claim 18, where
(i) step (A) includes storing the user interface rules as metadata in the rules base, and
(ii) processing said rules in step (B) includes converting the metadata into code that is executable on a digital data processor.

26. The method of claim 18, where the translatable elements comprise any of static text, enumerated variable text, images and icons.

27. The method of claim 18, wherein said request in step (A) is initiated by any of (i) a wizard interface and (ii) the entry of commands on a command interface.

28. The method of claim 18, wherein step (B) includes generating the translation facilitation package to further include any of (i) one or more previously translated elements for the one or more specified locales, and (ii) at least one indicator of exemplary reference by the specified one or more user interface rules of at least one translatable element and/or the previously translated element.

29. The method of claim 28, wherein step (A) includes identifying the translatable elements and previously translated elements by querying a database table comprising a plurality of entries, each entry having associated therewith,
(i) one or more translatable elements,
(ii) one or more previously translatable elements,
(iii) an identifier of a user interface rule that references said elements.

30. The method of claim 28, wherein step (A) includes identifying
(i) the translatable elements by inspecting the user interface rules, and
(ii) the previously translated elements by inspecting any of the transliteration rules, files and tables.

31. The method of claim 28, where the indicator of exemplary reference is any of
(i) a link to a markup file depicting a view of the translatable element and/or previously translated element, and
(ii) a textual description of the reference by the one or more user interface rules of the translatable element and/or previously translated element.

32. The method of claim 25, wherein processing the user interface rules in step (B) includes incorporating the translated elements into the code prior to said code executing on the digital data processor.

33. The method of claim 22, including the rules engine (i) importing the translation facilitation package with the translated elements contained therein, and (ii) generating any of the transliteration rules, files and tables by parsing the contents of the translation facilitation package to extract said translated elements.

34. The method of claim 23, including
(i) storing the user interface rules and transliteration rules as metadata in the rules base, and
(ii) the rules engine processing said rules in step (B) by converting the metadata associated with said rules into code that is executable on the digital data processor.

35. The method of claim 34, where the executable code in step (B) is Java code.

36. The method of claim 35, wherein processing the user interface in step (B) includes incorporating translated elements into the user interface rules prior to executing said code on said digital processor by transforming the metadata for the user interface rules and for the transliteration rules into a single executable Java class file.

37. A system for implementing a multilingual rules-based user interface, comprising:
A. a wizard executing on a first digital data processor of a first set of one or more digital data processors, said wizard in communications coupling with a rules base comprising a plurality of rules, the wizard (i) identifying one or more translatable elements referenced by one or more user interface rules in the rules base, (ii) requesting, from a user, one or more translated elements associated with such translatable elements and with at least one target locale, and (iii) generating one or more transliteration rules for such target locales,
B. a rules engine executing on a first digital data processor of a second set of one or more digital data processors, said rules engine in communications coupling with the rules base and with one or more transliteration rules, wherein the first and second sets may overlap, the rules engine
(i) retrieving from the one or more transliteration rules generated by the wizard one or more translated elements associated with
(a) one or more translatable elements in a first user interface rule in the rules base,
(b) a specified locale,
(ii) processing that first user interface rule using those one or more translated elements,
C. the rules engine generating, as a result of said processing, a user interface with the one or more translated elements.
